(19) United States
(12) Patent Application Publication
(10) Pub. No.: US 2003/0037521 A1
(43) Pub. Date: Feb. 27, 2003

(54) Liquid resistant filter assembly

(76) Inventors: Craig Chicks, Germantown, TN (US); Randy Harbur, Memphis, TN (US); Bruce Day, New Albany, MS (US); Ky Nguyen, Torrance, CA (US)

Correspondence Address: EDWARD A SOKOLSKI, 3868 CARSON STREET, 105, TORRANCE, CA, 90503, US

(21) Appl. No.: 09/934,389

(22) Filed: Aug. 21, 2001

(51) Int. Cl. B01D 46/00

(52) U.S. Cl. 55/497

(57) ABSTRACT

A filter assembly for use in filtering air in an air conditioning system has a water resistant front grille through which air enters the assembly and a water resistant rear grille through which filtered air is exited. The ends of these grilles are not apertured and are bent over and joined together to form a container structure. An air permeable filter element in the form of a pleated or undulating sheet is installed in the container structure, the opposite ends of the pleated sheet being attached to opposing sides of the grilles. The pleated sheet runs between the front and rear grilles and extends from the top to the bottom of the grilles. The filter sheet has a filtering media which may be of fiberglass on the side thereof which faces the front grille and a stiffened backing providing structural support, on the side facing the rear grille. The fiberglass, while passing air resists the passage of liquid therethrough. The top,bottom and front of the front grille have apertures formed therein for permitting the evacuation of water or other liquid.

### BACKGROUND OF THE INVENTION

1. Field of the Invention

This invention relates to air filters and more particularly to a filter assembly for use in air conditioning systems which utilizes an air permeable filter media in a pleated form and which will resist the passage of liquid therethrough.

2. Description of the Related Art

In air conditioning systems, the air filters employed must be capable of filtering out fine particles of foreign matter such as dirt particles and dust to avoid their entry into the air conditioned space. Filters capable of filtering out fine particles offer considerable resistance to the flow of air. One way of alleviating this problem is to provide a large area filtering surface by successively bending a flat filtering media back and forth on itself to form a pleated or undulated configuration. Such prior art filters are described in U.S. Pat. No. 4,177,050 issued Dec. 4, 1979 to Culbert, et al; U.S. Pat. No. 6,074,450 issued Jun. 13, 2000 to Raber.

It is frequently necessary to resist the passage of liquid through the filter due to the undesirability of having such liquid passing into the space on the down stream side of the filter. This end result must be achieved without hampering the air filtering action of the filter. Further, the filter element must be self supporting or having some mechanism for retaining it in position. The filter assembly of the present invention achieves the afformentioned desired end results in a filter assembly which provides optimum filtering action in a device of simple and economical construction.

### SUMMARY OF THE INVENTION

The device of the present invention overcomes the shortcomings of the prior art by providing a system employing an air filter which includes an undulating or pleated filter element of a material such as fiberglass which filters air but resists the passage of liquid. The filter element is bonded to a non-woven nylon backing to make the filter element self supporting, these two elements passing air but resisting the passage of liquid therethrough.

The filter element is mounted in a container formed by similar front and rear grille elements, the ends of which do not have apertures and are joined together. The grille elements are fabricated of a liquid impervious material. The ends of the grille elements are folded inwardly and joined together with a water resistant adhesive to form a cabinet for the filter element. The top and bottom ends of the filter element are attached to the top and bottom portions of the grille elements respectively with the side of the filter element having the filter media thereon facing the front grille element. Apertures are formed in the top and bottom portions of the faces of the grilles to permit the passage of liquid out from the cabinet.

It is therefore an object of this invention to provide an air filter assembly in which the passage of a liquid such as water therethrough is prevented.

It is a further object of this invention to provide a lightweight non metallic air filter which can be readily incinerated and more easily carried by maintenance personnel.

Other objects of the invention will become apparent in view of the following description taken in connection with the accompanying drawings.

### DESCRIPTION OF THE DRAWINGS

FIG. 1 is a front top perspective view of a preferred embodiment of the device of the invention;

FIG. 2 is a cross sectional view taken along the plane indicated by 2-2 in FIG. 1;

FIG. 3 is a fragmentary view taken on FIG. 2; and

FIG. 4 is an exploded view of the preferred embodiment.

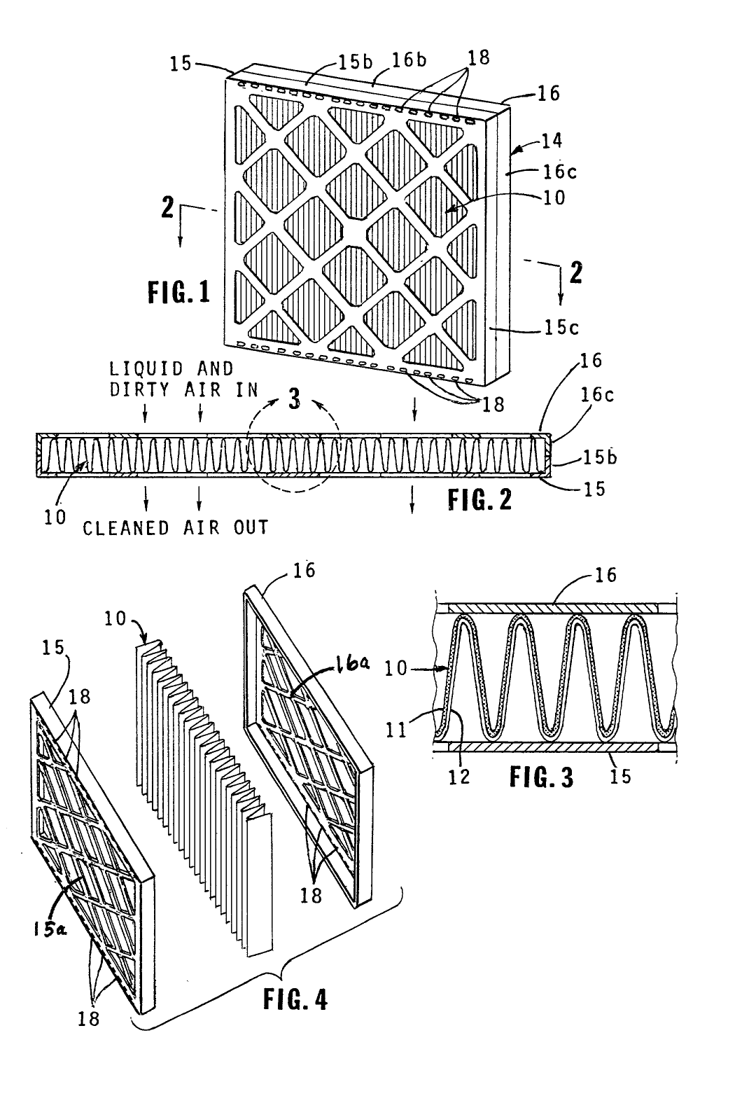

### DETAILED DESCRIPTION OF THE INVENTION

Referring now to the FIGS., filter element 10 is formed from a filtering media 11 on one side and a stiff support backing 12 on the other side. THe filtering media may be of a liquid impervious material such as fiberglass formed into an integral mat and the support backing may be formed from a non-woven nylon backing which enables the filtering media to be self standing. The two units are joined together with a thermosetting plastic binder. The filter element is formed into a pleated undulated structure, as can best be seen in FIG. 4, by folding a sheet of the material back on itself in opposite directions.

The filter element is mounted in a container 14 formed by front and rear grille elements 15 and 16 respectively. The grille elements have cross hatched openings 15a and 16a in their broad surfaces and have end and side portions 15b, 15c and 16b, 16c which are folded back. The end and side portions of the two grille elements are joined together along their edges with a water resistant adhesive to form the container 14.

The top end of the filter element is cemented to the top end of the front grille element 15 and the bottom end of this element cemented to the bottom end of the rear grille element with the surface of the filter element on which the filtering media is formed facing the front grille portion.

Apertures 18 are formed along the bottom and upper and lower edges of the container to permit any accululation of liquid to flow out of the container. Both the upper and lower surfaces are apertured so that the unit can be turned upside down without affecting the draining action.

The device of the invention thus is of simple and economical construction as compared with prior art systems utilizing pleated filter elements yet emables self standing of the filter and restrains the passage of liquid therethrough.

While the invention has been described and illustrated in detail, this is intended by way of illustration and example only, the scope of the invention being limited by the terms of the following claims.

We claim:

1. An air filter comprising:
front and rear grille elements fabricated of a liquid impermeable material,
the end portions of said grille elements being joined together to form a container structure having a base portion with apertures formed therein for passing liquid from said container structure, and
an air permeable filter element in the form of a pleated sheet attached at its top and bottom ends to the top and bottom ends of said front grille element respectively, said pleated sheet running between said front and rear grille elements over substantially the entire extent of said grille elements, said pleated sheet being fabricated of a liquid resistant material.

2. The air filter of claim 1 wherein said filter element includes a liquid resistant air permeable backing attached to one side of said pleated sheet to make said sheet self supporting.

3. The air filter of claim 1 wherein said filter element is fabricated of fiberglass.

4. The air filter of claim 3 wherein said backing comprises non-woven nylon.

5. The air filter of claim 1 wherein the end portions of said grille elements are bent towards each other so that they come together, said end portions being joined together with a water resistant adhesive.

6. The air filter of claim 1 wherein said apertures in the base portion of said container structure are formed in said front grille element.
